(19) United States
(12) Patent Application Publication
(10) Pub. No.: US 2015/0312157 A1
(43) Pub. Date: Oct. 29, 2015

(54) METHOD FOR ALIGNING QoS OF WLAN AND QoS OF PACKET CORE NETWORK

(71) Applicant: ZTE CORPORATION, Shenzhen, Guangdong (CN)

(72) Inventor: Guanghui Liu, Shenzhen City (CN)

(21) Appl. No.: 14/646,768

(22) PCT Filed: Sep. 26, 2013
(86) PCT No.: PCT/CN2013/084340

§ 371 Date: May 22, 2015

(30) Foreign Application Priority Data
Dec. 27, 2012 (CN) 201210576569.3

(51) Int. Cl. H04L 12/857; H04L 12/863; H04W 76/02; H04L 29/06

(52) U.S. Cl. CPC H04L 47/2491; H04L 65/80; H04L 47/6215; H04W 76/022; H04W 84/12

(57) ABSTRACT

A method for aligning QoS of a WLAN network and QoS of a packet core network is disclosed. The method includes: establishing multiple first Internet Protocol Security (IPSEC) tunnels between a User Equipment (UE) and a WLAN, each first IPSEC tunnel corresponding to a different bearer, and transporting different DSCP values of different bearers to the WLAN via the first IPSEC tunnels; establishing multiple second IPSEC tunnels between the WLAN and the packet core network, mapping the different DSCP values to different Quality of Services (QoSs) on the WLAN, and transporting the QoSs to the packet core network via the second IPSEC tunnels; and the WLAN performing QoS scheduling on services of the bearers according to the different DSCP values.

### TECHNICAL FIELD

The present invention relates to the field of communications, and in particular, to a method for aligning QoS of a Wireless Local Area Network (WLAN) and QoS of a packet core network.

### BACKGROUND OF THE RELATED ART

As wireless and terminal technologies continuously progress, the mobile Internet increasingly shows its great potential for development. More and more users are in the use of mobile Internet, and more and more services are moved from a fixed network to the mobile Internet. People can obtain any needed network information service through the mobile Internet at any time and in any place. The next generation core network is a converged network. For the next generation packet core network, it can be independent of a single wireless access technology, while accomplishing access functions of multiple wireless technologies such as Universal Mobile Telecommunications System (UMTS)/Code Division Multiple Access (CDMA)/Long Term Evolution (LTE)/Worldwide Interoperability for Microwave Access (WiMax)/wireless local area network based on IEEE 802.11b standard (WiFi) etc., and accessing multiple wireless access functional entities such as Gateway GPRS Support Node (GGSN)/Packet Data Support Node (PDSN)/SAE GW/Access GateWay (AGW)/PDG etc. to the same converged network element.

Quality of Service (QoS) is a kind of network security mechanism, which allows the user services to reach an expected service level in terms of packet loss rate, delay, jitter, and bandwidth etc. in the process of network communication. QoS in grouping access network elements is generally contracted according to a level of a service flow tunnel of each user. In addition, the wireless packet access protocol generally divides QoS required by a user into several categories, and a QoS priority, a minimum bandwidth requirement, a maximum bandwidth limit, delay, and jitter, etc. are then respectively specified in each category. These QoSs will be issued to the packet access gateway and the wireless base station device with negotiation or contract of the user, and presents scheduling of wireless resources in the air interface. On the packet access gateway device, it needs to perform scheduling by mapping the categories of QoS contracted for the services into the QoS of the bearer layers. With the expansion of users on the access gateway and increase of service categories, the access gateway device is required to not only subdivide the service traffic, but also perform uniform management and hierarchical scheduling on the transmission objects such as multiple users, a variety of services, a variety of traffics etc.

When users use mobile Internet through the WLAN, how to ensure consistency between QoS of the WLAN network and QoS of the packet core network for the users, and especially when multiple bearers are accessed in which case services performed on various bearers may be different, how to ensure that QoS of each service of each bearer is guaranteed have not been solved yet.

### SUMMARY OF THE INVENTION

In order to solve the above technical defects, the present invention provides a method for aligning QoS of a Wireless Local Area Network (WLAN) network and QoS of a packet core network, which aims to ensure alignment of the QoS of the WLAN network and the QoS of the packet core network when the mobile Internet is used through the WLAN, thereby improving user experience, and avoiding degradation and interruption of the user's QoS due to inconsistency between QoSs on both ends.

In order to achieve the above purpose, the present invention uses the following technical schemes.

A method for aligning QoS of a Wireless Local Area Network (WLAN) and QoS of a packet core network comprises:

establishing multiple second Internet Protocol Security (IPSEC) tunnels between the WLAN and the packet core network, mapping different Differentiated Services Code Point (DSCP) values to different Quality of Services (QoSs) on the WLAN, and transporting the QoSs to the packet core network via the second IPSEC tunnels.

Preferably, the DSCP values are different DSCP values of different bearers created by the UE, and the DSCP values are transported to the WLAN via first IPSEC tunnels established between the UE and the WLAN.

Preferably, the method further comprises: the WLAN performing QoS scheduling on services of the bearers according to the different DSCP values.

Preferably, mapping the different DSCP values to different QoSs on the WLAN is implemented by a configuration command.

A user equipment comprises:

a connection apparatus, configured to establish multiple Internet Protocol Security (IPSEC) tunnels with a Wireless Local Area Network (WLAN), each IPSEC tunnel corresponding to a different bearer, and different Differentiated Services Code Point (DSCP) values of different bearers being transported to the WLAN via the IPSEC tunnels.

A Wireless Local Area Network (WLAN) system comprises:

a connection apparatus, configured to establish multiple Internet Protocol Security (IPSEC) tunnels with a packet core network system;

a mapping apparatus, configured to map different Differentiated Services Code Point (DSCP) values to different Quality of Services (QoSs) on the WLAN; and

a transmission apparatus, configured to transmit the mapped QoSs to the packet core network system via the IPSEC tunnels.

Preferably, the WLAN system further comprises:

a scheduling apparatus, configured to perform QoS scheduling on services of the bearers according to the different DSCP values.

As the above technical schemes are used, the embodiments of the present invention can include the following advantages: it can be effectively guaranteed that uniform QoS is used between the UE and the WLAN and between the WLAN and the packet core network for scheduling, and especially when multiple bearers are accessed, end-to-end QoS can be effectively guaranteed.

### BRIEF DESCRIPTION OF DRAWINGS

The accompanying drawings described herein are used to provide a further understanding of the present invention and constitute a part of this application, and the exemplary embodiments of the present invention and the descriptions thereof are used to explain the present invention and do not constitute an improper definition of the present invention. In the accompanying drawings:

FIG. 1 is a structural diagram of a system according to an embodiment of the present invention; and

FIG. 2 is a flowchart of a method according to an embodiment of the present invention.

### PREFERRED EMBODIMENTS OF THE PRESENT INVENTION

The present invention will be further described in detail below in conjunction with accompanying drawings and specific embodiments. It should be illustrated that the embodiments in the present application and various implementations in the embodiments can be combined with each other without conflict.

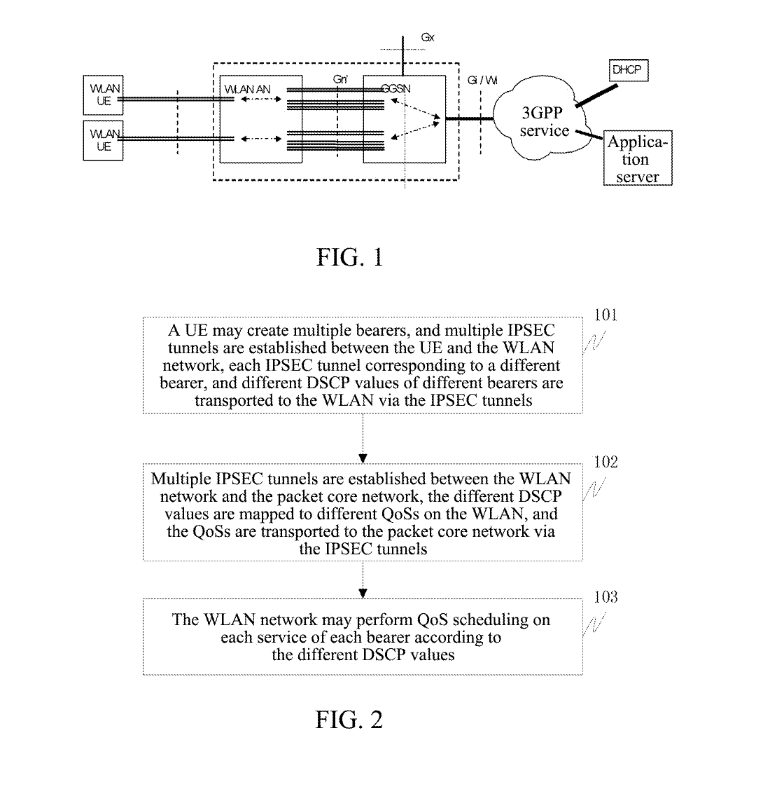

As shown in FIGS. 1-2, creation of multiple bearers may be initiated by a UE, or may also be initiated by a Policy and Charging Rules Function (PCRF) network element at the network side. The PCRF network element is a device at the network side, to support Policy and Charging Control (PCC) services, and may provide PCC services to a GateWay (GW) network element of a packet core network, comprising issuing QoSs. The GW network element may be configured to prioritize the QoS carried by a message or the QoS issued by the PCRF. In applications, the QoS issued by the PCRF is generally prioritized.

A method for aligning QoS of a Wireless Local Area Network (WLAN) network and QoS of an Evolved Packet Core (EPC) network (or another packet core network) comprises the following steps.

In step 101, a UE may create multiple bearers, and multiple IPSEC tunnels are established between the UE and the WLAN network, each IPSEC tunnel corresponding to a different bearer, and different DSCP values of different bearers created by the UE are transported to the WLAN via the IPSEC tunnels.

In step 102, multiple IPSEC tunnels are established between the WLAN network and the packet core network, the different DSCP values are mapped to different QoSs on the WLAN, and the QoSs are transported to the packet core network via the IPSEC tunnels.

Wherein, mapping the different DSCP values to different QoSs on the WLAN is implemented by a configuration command. For example, the configuration is as follows.

max-down-br background begin 1 end 20 dscp 1 may specify a range of MBR corresponding to a certain DSCP value in the downlink. The method is the same for the uplink, and the method is similar for GBR etc.

In step 103, the WLAN network may perform QoS scheduling on each service of each bearer according to the different DSCP values.

QoS scheduling refers to that an edge convergence device performs QoS scheduling in advance for downlink (from the backbone network to the access network) traffics according to factors such as a topology structure, a network processing capability etc. of the access network using measures such as traffic shaping, congestion avoidance etc., to enable the traffic of the access network to be relatively stable, thereby avoiding congestion in the access network. After the QoS scheduling is used on the edge convergence device, the requirements on the QoS capability of a layer two device can be reduced. On one hand, the construction cost and the maintenance cost of the layer two network can be reduced, and on the other hand, the QoS effects of the whole network can also be improved.

The packet core network may be an EPC, or may also be a GGSN etc., and during the implementation, it is not limited thereto.

In the present embodiment, the UE accesses to the packet core network through the WLAN, and then accesses to multiple mobile networks such as a 3GPP service network through the packet core network, which can not only access to many kinds of resources, but also can achieve a fast speed, thereby guaranteeing QoS of each service of each bearer.

The present invention further provides a system for aligning QoS of a Wireless Local Area Network (WLAN) and QoS of a packet core network, which may comprise:

a UE, configured to establish multiple first IPSEC tunnels with a Wireless Local Area Network (WLAN), each first IPSEC tunnel corresponding to a different bearer, and different Differentiated Services Code Point (DSCP) values of different bearers being transported to the WLAN via the first IPSEC tunnels; and

a Wireless Local Area Network (WLAN) system, which may comprise:

a connection apparatus, configured to establish multiple second IPSEC tunnels with a packet core network system;

a mapping apparatus, configured to map different DSCP values to different Quality of Services (QoSs) on the WLAN and transport the mapped QoSs to the packet core network system via the second IPSEC tunnels; and

a transmission apparatus, configured to transmit the mapped QoSs to the packet core network system via the second IPSEC tunnels.

The WLAN system may further comprise a scheduling apparatus, configured to perform QoS scheduling on services of the bearers according to the different DSCP values.

Wherein, packet core network system may be an EPC system, and during the implementation, it is not limited thereto.

The above description is only the preferred embodiments of the present invention and it is not intended to limit the protection scope of the present invention. Without departing from the spirit and scope of the present invention, those skilled in the art can make various changes and variations to present invention. Thus, if these changes and variations of the present invention belong to the scope of the inventive claims and the equivalent technologies thereof, the invention is also intended to include these changes and variations.

### INDUSTRIAL APPLICABILITY

According to the embodiments of the present invention, it can be effectively guaranteed that uniform QoS is used between the UE and the WLAN and between the WLAN and the packet core network for scheduling, and especially when multiple bearers are accessed, end-to-end QoS can be effectively guaranteed.

1. A method for aligning Quality of Service (QoS) of a Wireless Local Area Network (WLAN) and QoS of a packet core network, comprising:
establishing multiple second Internet Protocol Security (IPSEC) tunnels between the WLAN and the packet core network, mapping Differentiated Services Code Point (DSCP) values to QoSs on the WLAN, and transporting the QoSs to the packet core network via the second IPSEC tunnels.

2. The method according to claim 1, wherein,
the DSCP values are different DSCP values of different bearers created by a user equipment (UE), and the DSCP values are transported to the WLAN via first IPSEC tunnels established between the UE and the WLAN.

3. The method according to claim 1, further comprising:
the WLAN performing QoS scheduling on services of the bearers according to the different DSCP values.

4. The method according to claim 3, wherein,
mapping the different DSCP values to different QoSs on the WLAN is implemented by a configuration command.

5. A user equipment, comprising:
a connection apparatus, configured to establish multiple Internet Protocol Security (IPSEC) tunnels with a Wireless Local Area Network (WLAN), each IPSEC tunnel corresponding to a different bearer, and different Differentiated Services Code Point (DSCP) values of different bearers being transported to the WLAN via the IPSEC tunnels.

6. A Wireless Local Area Network (WLAN) system, comprising:
a connection apparatus, configured to establish multiple Internet Protocol Security (IPSEC) tunnels with a packet core network system;
a mapping apparatus, configured to map different Differentiated Services Code Point (DSCP) values to different Quality of Services (QoSs) on the WLAN; and
a transmission apparatus, configured to transmit the mapped QoSs to the packet core network system via the IPSEC tunnels.

7. The system according to claim 6, wherein, the WLAN system further comprises:
a scheduling apparatus, configured to perform QoS scheduling on services of bearers according to the different DSCP values.

8. The method according to claim 2, further comprising:
the WLAN performing QoS scheduling on services of the bearers according to the different DSCP values.

9. The method according to claim 8, wherein,
mapping the different DSCP values to different QoSs on the WLAN is implemented by a configuration command.
